(19) United States
(12) Patent Application Publication
(10) Pub. No.: US 2019/0247968 A1
(43) Pub. Date: Aug. 15, 2019

(54) WORKPIECE SUPPORTING JIG

(71) Applicant: Sumitomo Electric Sintered Alloy, Ltd., Takahashi-shi (JP)

(72) Inventors: Yuki Tsukamoto, Takahashi-shi (JP); Tomoya Tamura, Takahashi-shi (JP)

(21) Appl. No.: 15/746,829

(22) PCT Filed: Sep. 6, 2017
(86) PCT No.: PCT/JP2017/032074

§ 371 Date: Jan. 23, 2018

(30) Foreign Application Priority Data
Jan. 18, 2017 (JP) 2017-006906

(51) Int. Cl. B23Q 3/06; B22F 3/24; B22F 5/00

(52) U.S. Cl. CPC B23Q 3/062; B22F 2003/1042; B22F 5/006; B22F 3/24

(57) ABSTRACT

Provided is a jig for supporting a plate-shaped workpiece made of a sintered compact when subjecting the workpiece to a steam treatment. The jig is provided with a bottom plate configured to support a plurality of workpieces in a stacked manner, and a guide rod erected on one surface of the bottom plate to position the stacked workpieces. An opening configured to allow supplied steam to pass through downward is formed in a vicinity of a portion of the bottom plate on which the workpiece is to be supported.

### TECHNICAL FIELD

The present invention relates to a workpiece supporting jig.

The present application claims priority to Japanese patent application No. 2017-006906 filed on Jan. 18, 2017, the contents of which are incorporated by reference in their entirety.

### BACKGROUND ART

When a sintered compact obtained by shaping and sintering an iron-based powder material is required to have relatively strict dimensional accuracy, in some cases, the sintered compact is subjected to a sizing treatment. Further, in order to improve rust prevention and abrasion resistance, a sintered compact which has been subjected to a sizing treatment is sometimes further subjected to a steam treatment.

A steam treatment is a process for forming a black rust protective film composed of triiron tetraoxide (Fe₃O₄) on a sintered compact by supplying high temperature steam to the sintered compact arranged in a sealed furnace to cause a reaction between the steam and the iron on the surface of the sintered compact.

Normally, in a steam treatment, a plurality of sintered compacts (hereinafter also referred to as “workpieces”) is arranged in a furnace, and the plurality of workpieces is processed simultaneously. Conventionally, the workpiece after the sizing treatment is arranged in a box-shaped container made of punching metal with its top opened, and the containers stacked in a plurality of stages (e.g., about 10 stages) are loaded into a furnace and subjected to a steam treatment (see, for example, Patent Document 1). In each container, about three pieces of workpieces were arranged in a stacked manner.

### PRIOR ART

### Patent Document

Patent Document 1: Japanese Unexamined Patent Publication No. 188308/1997

### SUMMARY OF THE INVENTION

A workpiece supporting jig according to the present disclosure is a jig for supporting a workpiece when subjecting a plate-shaped workpiece made of a sintered compact to a steam treatment. The jig is equipped with a bottom plate on which a plurality of workpieces is to be supported in a stacked manner, and a guide rod erected on one surface of the bottom plate to position the stacked workpieces. An opening for allowing supplied steam to pass through downward is formed in a vicinity of a portion of the bottom plate on which the workpiece is to be placed.

### BRIEF DESCRIPTION OF THE DRAWINGS

FIG. 1 is a plan explanatory view showing an example of a workpiece for which a workpiece supporting jig of the present invention can be used.

FIG. 2 is a plan explanatory view of a bottom plate of an embodiment of the workpiece supporting jig for supporting the inner rotor shown in FIG. 1.

FIG. 3 is a plan explanatory view of a lifter plate of an embodiment of a workpiece supporting jig for supporting the inner rotor shown in FIG. 1.

FIG. 4 is a cross-sectional explanatory view of an embodiment of a workpiece supporting jig for supporting the inner rotor shown in FIG. 1.

FIG. 5 is a plan explanatory view of a bottom plate of an embodiment of a workpiece supporting jig for supporting the outer rotor shown in FIG. 1.

FIG. 6 is a plan explanatory view of a lifter plate of an embodiment of a workpiece supporting jig for supporting the outer rotor shown in FIG. 1.

FIG. 7 is a cross-sectional explanatory view of an embodiment of a workpiece supporting jig for supporting the outer rotor shown in FIG. 1.

### EMBODIMENTS FOR CARRYING OUT THE INVENTION

### Problems to be Solved by the Disclosure

However, in a conventional container, since workpieces are merely arranged on a bottom plate of a container, there is a possibility that the workpieces collide with each other when carrying the container to cause scratches or damage to the workpieces. Further, since a gap or a dead space is formed between the rear surface of a bottom plate of the upper stage container and the top surface of the uppermost workpiece of the lower stage container, there is a limit in the amount of workpieces that can be simultaneously processed in a furnace.

Therefore, the purpose of the present disclosure is to provide a workpiece supporting jig capable of increasing a processing amount of workpieces without causing damage to the workpieces.

### Effects of the Disclosure

According to the present disclosure, the processing amount of workpieces can be increased without causing damage to the workpieces.

### DETAILED DESCRIPTION OF EMBODIMENTS OF THE PRESENT INVENTION

First, embodiments of the present invention will be described.

A workpiece supporting jig (hereinafter also simply referred to as “jig”) according to one embodiment of the present invention is configured as follows.

(1) A workpiece supporting jig for supporting a plate-shaped workpiece made of a sintered compact when subjecting the workpiece to a steam treatment, includes

a bottom plate configured to support a plurality of workpieces in a stacked manner, and

a guide rod erected on one surface of the bottom plate to position stacked workpieces,

wherein an opening configured to allow supplied steam to pass through downward is formed in a vicinity of a portion of the bottom plate on which the workpiece is to be supported.

Since the jig according to this embodiment can support workpieces on the bottom plate of the jig in a stacked manner, a dead space which will be formed in the case of using a conventional container can be eliminated, which in turn can increase the processing amount of workpieces. At that time, the stacked workpieces are guided or positioned by the guide rod erected on the bottom plate, and therefore the workpieces will not be scratched or damaged during the conveyance due to collision therebetween. Furthermore, since the opening configured to allow the supplied steam to pass through downward is formed in the vicinity of the bottom plate portion on which the workpiece is to be supported, circulation of the steam in the furnace can be improved. In other words, it is possible to suppress or prevent stagnation of the steam in the furnace, which can prevent the occurrence of a film formation defect in the workpiece.

(2) In the jig as recited in the aforementioned Item (1), it is preferable that a plurality of openings be formed in the bottom plate and that a total area of the plurality of openings be 14% to 85% of an area of the bottom plate. In this case, it is possible to keep the weight of the bottom plate within a certain range while securing circulation of the steam. If the opening ratio is increased, the circulation of the steam can be improved by that amount. On the other hand, it is necessary to increase the strength of the bottom plate by increasing the thickness of the bottom plate.

(3) In the jig as recited in the aforementioned Item (1) or (2), it may be configured such that the workpiece is formed into a disc shape, an inner diameter surface or an outer diameter surface of the workpiece is served as a sliding surface which comes into slide contact with another member, and the guide rod is erected on an inner diameter side or an outer diameter side opposite to the sliding surface of the workpiece. In this case, the guide rod is erected on a side of the workpiece opposite to the sliding surface of the workpiece, that is, in the case in which the inner diameter side of the workpiece is served as a sliding surface, the guide rod is erected on the outer diameter side of the workpiece and in the case in which the outer diameter side of the workpiece is served as a sliding surface, the guide rod is erected on the inner diameter side of the workpiece. Therefore, the guide rod and the sliding surface of the workpiece would not contact with each other. At the part of the workpiece which comes into contact with the guide rod, there is a possibility of the occurrence of a film formation defect. However, since the sliding surface of the workpiece never comes into contact with the guide rod, it is possible to assuredly prevent the occurrence of a film formation defect on the sliding surface to which high accuracy is particularly required.

### DETAILED DESCRIPTION OF EMBODIMENTS OF THE PRESENT INVENTION

Hereinafter, some embodiments of a jig according to the present invention will be described. It should be noted that the present invention is not limited to these exemplified embodiments, but is intended to include configurations defined by the claims and all modifications having meaning and scope equivalent to the claims.

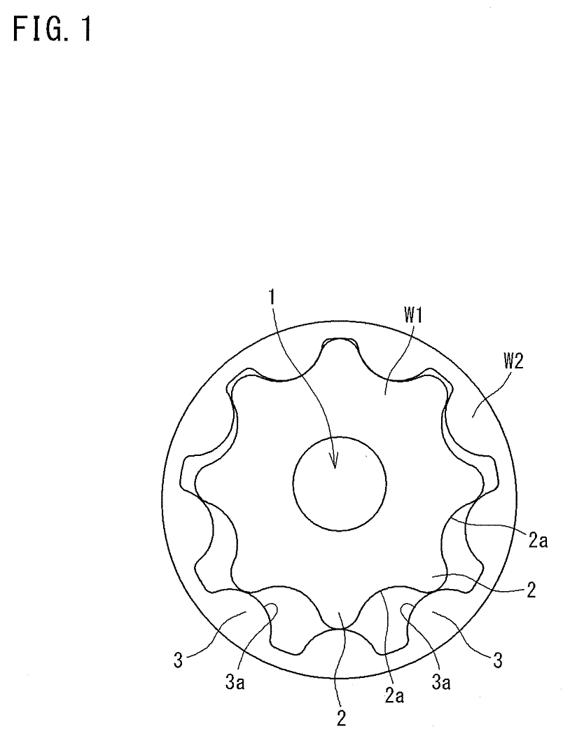

FIG. 1 is a plan explanatory view showing an inner rotor W1 and an outer rotor W2 of an internal gear pump, which are examples of workpieces to which a workpiece supporting jig of the present invention can be applied. Both the inner rotor W1 and the outer rotor W2 can be obtained by subjecting a sintered compact obtained by shaping and sintering an iron-based powder material to a sizing treatment and further subjecting it to a steam treatment for the purpose of improving rust prevention and abrasion resistance.

The inner rotor W1 is formed into a disc shape. A round hole 1 in which a rotation shaft (not shown) is to be press-fitted is formed at the center of the inner rotor W1, and an outer peripheral teeth 2 which is engaged with an inner peripheral teeth of an outer rotor W2, which will be described later, is formed on an outer diameter of the inner rotor W1. The outer peripheral surface 2a of the outer peripheral teeth 2 of the inner rotor W1, that is, the outer diameter surface of the inner rotor W1, is served as a sliding surface which comes into slide contact with the inner peripheral surface of the inner peripheral teeth of the outer rotor W2.

The outer rotor W2 is formed into a disk shape, and an inner peripheral teeth 3 which is engaged with the outer peripheral teeth 2 of the inner rotor W1 is formed on the inner diameter surface of the outer rotor W2. The inner peripheral surface 3a of the inner peripheral teeth 3 of the outer rotor W2, that is, the inner diameter surface of the outer rotor W2, is served as a sliding surface which comes into slide contact with the outer peripheral surface 2a of the outer peripheral teeth 2 of the inner rotor W1.

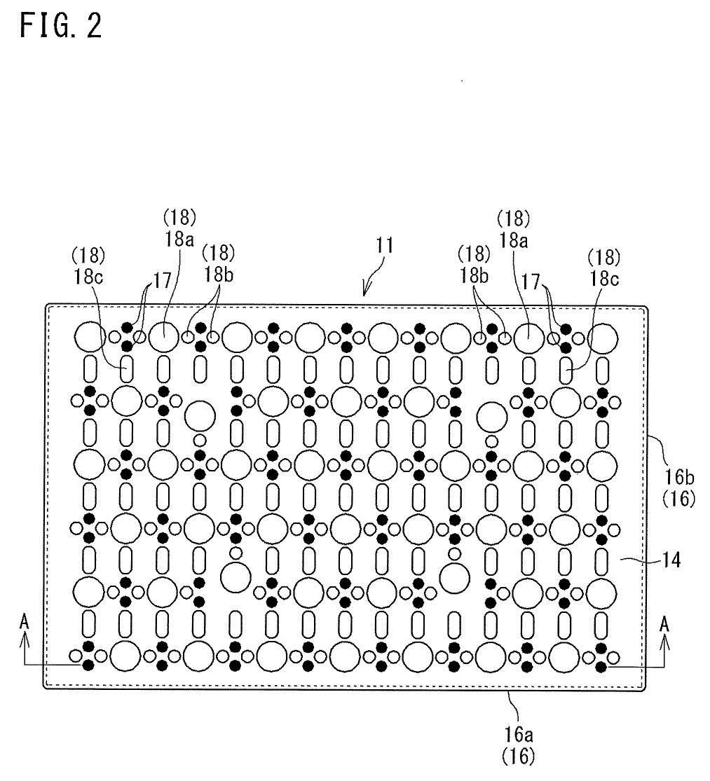

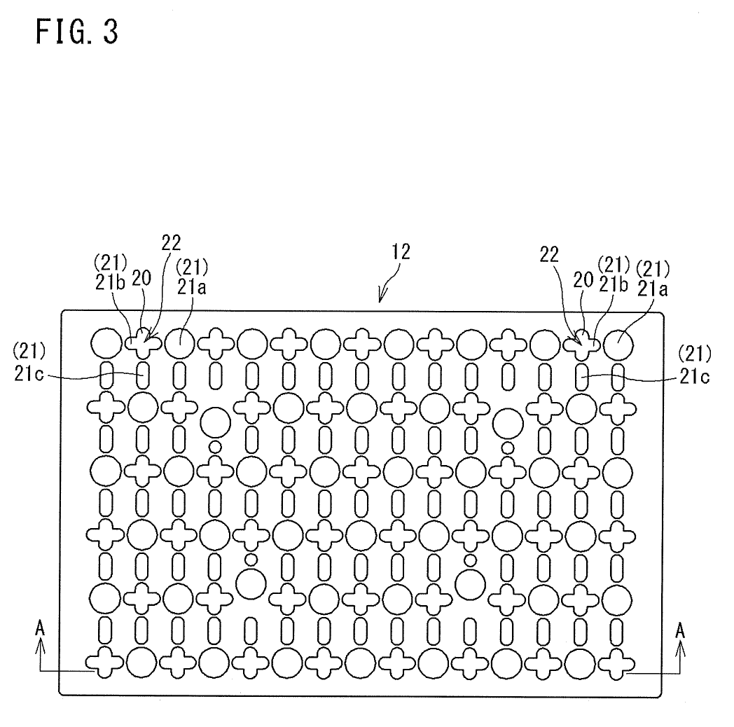

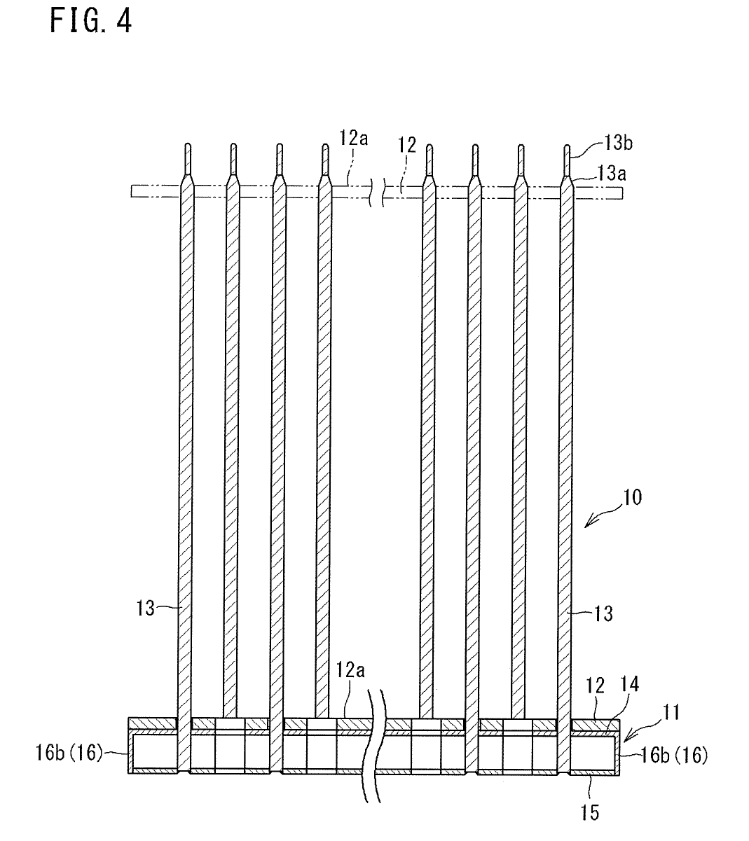

FIGS. 2 to 4 are explanatory views showing one embodiment of a jig for supporting a workpiece having a disk shape similar to the inner rotor W1 shown in FIG. 1 when the workpiece whose outer diameter surface is served as a sliding surface is subject to a steam treatment. As shown in FIG. 4, the jig 10 according to one embodiment of the present invention is equipped with a bottom plate 11, a lifter plate 12, and guide rods 13. FIG. 2 is a plan explanatory view of the bottom plate 11. FIG. 3 is a plan explanatory view of the lifter plate 12. FIG. 4 is a cross-sectional explanatory view of the jig 10 in which the bottom plate 11, the lifter plate 12, and the guide rods 13 are assembled, and is a cross-sectional view taken along the line A-A when the bottom plate 11 and the lifter plate 12 shown in FIGS. 2 and 3 are combined. The bottom plate 11, the lifter plate 12, and the guide rod 13 can be each made of a general steel material, such as, e.g., SS41.

The bottom plate 11 is a member for supporting workpieces W (W1) in a stacked manner, and the bottom plate 11 in this embodiment has a rectangular box shape. The bottom plate 11 is equipped with a rectangular upper plate 14, a lower plate 15 having the same shape as the upper plate 14, and four side plates 16 (see FIG. 4). The side plate 16 is composed of a side plate 16a on the long side of the rectangular upper plate 14 and the lower plate 15 and a side plate 16b on the short side thereof. The side plate 16 in this embodiment is formed by bending the edge portion of the upper plate 14. The tip end portion of the bent side plate 16 is fixed to the edge portion of the lower plate 15 by welding or the like. The side plate 16 can also be formed by bending the edge portion of the lower plate 15. Furthermore, the side plate 16 may be formed as a separate member from the upper plate 14 and the lower plate 15, and the side plate 16 may be fixed to the upper plate 14 and the lower plate 15.

In the upper plate 14 and the lower plate 15 of the bottom plate 11, a round hole 17 which is an opening through which the guide rod 13 is to be inserted, and an opening which allows steam supplied for a steam treatment to pass through downward (in a direction from the uppermost workpiece W (W1) toward the lowermost workpiece W (W1) with reference to the direction of stacking workpieces W (W1), and a direction toward downward in FIG. 4, in other words, a direction from the tip end of the guide rod 13 erected on the bottom plate 11 toward the base portion thereof). The round hole 17 and the opening 18 of the upper plate 14 and the round hole 17 and the opening 18 of the lower plate 15 are formed at positions overlapping each other in the vertical direction (vertical direction in FIG. 4) when the upper plate 14 is placed at a predetermined position on the lower plate 15.

The opening 18 is composed of an opening 18a formed of a large round hole, an opening 18b formed of a round hole having a diameter smaller than that of the large round hole, and an oval opening 18c. In FIG. 2, for the sake of clarity, the round hole 17 which is an opening through which the guide rod 13 is inserted is illustrated by a black filled circle. The opening 18 is regularly formed in the vicinity of a part or a region where the workpiece W is supported on the bottom plate 11 in order to improve the flow of the steam around the workpiece W (W1). In this embodiment, the opening 18 and the workpiece W (W1) are partially overlapped in the vertical direction (vertical direction in FIG. 4), but the shape and the arrangement of the opening 18 can be selected so as not to be overlapped with each other.

The type (three types of opening is adopted in this embodiment), the number, the size, and the arrangement of the opening 18 are not particularly limited in the present invention, and they can be appropriately selected in consideration of the easiness of steam circulation, the shape and size of the workpiece, the strength of the bottom plate, etc. As the total area of the openings 18 (the total area of the plurality of opening areas formed in the bottom plate) becomes larger, the circulation of the steam becomes better. Since the strength of the bottom plate decreases when the total area is excessively large, it is generally 14% to 85% as a standard, preferably 16% to 80%, with respect to the area of the bottom plate.

In this embodiment, the inner diameter side of the workpiece W (W1) opposite to the sliding surface is guided or positioned by a pair of guide rods 13 inserted into a pair of round holes 17 formed vertically adjacent to each other in FIG. 2. That is, in this embodiment, a pair of adjacent guide rods 13 is inserted into the round hole 1 of the workpiece W (W1). Therefore, the guide rods 13 do not come into contact with the sliding surface of the workpiece W (W1), so that it is possible to prevent the occurrence of a film formation defect of the sliding surface due to the contact between the sliding surface and the guide rods 13.

Note that the number of guide rods for guiding or positioning the inner diameter side of the workpiece W (W1) is not limited to two, but may be one or three or more.

In the example shown in FIGS. 2 to 4, the pair of guide rods 13 is arranged in six rows in the short side direction of the rectangular bottom plate 11 and in seven or eight rows in the long side direction thereof. That is, six (6) pairs of guide rods 13 are arranged in the short side direction, and seven (7) pairs or eight (8) pairs of guide rods 13 are arranged in the long side direction. Forty five (45) pairs of guide rods 13 are arranged on one bottom plate 11, so that forty five (45) workpieces W (W1) can be arranged side by side in one stage. In the case of stacking n stages of workpieces W (W1) on the bottom plate 11, a total of 45×n workpiece W (W1) can be supported on the bottom plate 11.

The guide rod 13 in this embodiment is composed of a solid rod material having a circular cross-section, and a tapered portion 13a and a small-diameter portion 13b connected to the small diameter side end portion of the tapered portion 13a are formed at the tip end portion of the guide rod 13. The tip of the small-diameter portion 13b is curved in a dome-shaped. Since the tapered portion 13a and the small-diameter portion 13b are formed, it is easy to insert the tip end portion of the guide rod 13 into the round hole 1 of the workpiece W (W1).

In order to improve the circulation of the steam, a hollow rod member having a plurality of holes or openings formed in the peripheral wall can be used instead of a solid rod material.

The guide rod 13 can be provided on the bottom plate 11 in an erected manner by, for example, inserting the root portion of the guide rod 13 which is a side opposite to the tip end portion into the round hole 17 in the upper plate 14 of the bottom plate 11 and the round hole formed in the lower plate 15 at the position corresponding to the round hole 17, and tap-welding the tip peripheral edge of the root portion and the peripheral edge portion of the round hole of the lower plate.

In this embodiment, a lifter plate 12 as shown in FIG. 3 is disposed on the bottom plate 11. The workpiece W (W1) is supported on this lifter plate 12. In this specification, “the workpiece is supported” means to not only include the case in which the workpiece is directly supported on the bottom plate but also include the case in which the workpiece is indirectly supported on the bottom plate via another member called a lifter plate like in this embodiment.

The lifter plate 12 can be made of a steel material such as SS41 in the same manner as the bottom plate 11. Unlike the bottom plate 11, the lifter plate 12 is made of one sheet material. The lifter plate 12 has a rectangular shape approximately the same size as the bottom plate 11 in a plan view, and is provided with openings 20 and openings 21 (21a, 21b, 21c) formed at positions corresponding to the positions where the round hole 17 and the opening 18 (18a, 18b, 18c) of the bottom plate 11 are formed, respectively. In other words, when the lifter plate 12 is laid over the bottom plate 11, the position, the size, and the shape of the opening 20 and the openings 21a, 21b, and 21c of the lifter plate 12 are set so that the round hole 17 and the openings 18a, 18b, and 18c of the bottom plate 11 and the opening 20 and the openings 21a, 21b, and 21c of the lifter plate 12 substantially coincide vertically so as to be penetrated. However, in this embodiment, the round hole 17 into which the guide rod 13 is inserted and the small round hole in the vicinity thereof are formed separately from each other in the bottom plate 11. However, in the lifter plate 12, the opening 20 and the opening 21b corresponding to the round hole 17 and the opening 18b are integrally formed as one approximately cross-shaped opening 22.

The lifter plate 12 is movable up and down along the axial direction of the guide rod 13 by a drive mechanism (not illustrated). At the time of initiating supporting of the workpiece W (W1) on the lifter plate 12, the lifter plate 12 is in a raised position indicated by the two-dot chain line in FIG. 4. In this raised position, the tip end portion of the guide rod 13 is protruded by about 4 cm from the upper surface 12a of the lifter plate 12. In this state, workpieces W (W1) are sequentially arranged on the lifter plate 12 by using a handling device (not illustrated) or the like. More specifically, workpieces W (W1) are arranged on the lifter plate 12 so that the tip end portion of the guide rod 13 protruding from the upper surface 12a of the lifter plate 12 is inserted into the round hole 1 of the workpiece W (W1).

When the first stage arrangement of the workpieces W (W1) is completed, the lifter plate 12 is descended by the thickness of the workpiece W (W1) with the drive mechanism. If the thickness of the workpiece W (W1) is 10 mm, the lifter plate 12 is descended by 10 mm. As a result, it becomes a state in which the tip end portion of the guide rod 13 protrudes from the upper surface of the first stage workpiece W (W1) by the same distance as when it is at the raised position described above. Then, in the same manner as the 1^{st} stage workpiece W (W1), the 2^{nd} stage workpiece W (W1) is sequentially arranged. Thereafter, in the same manner, the 3^{rd} stage, the 4^{th} stage, . . . , the ⁿth stage workpieces W (W1) are arranged.

When predetermined n^{th} stage workpieces W (W1) are supported on the lifter plate 12, the jig 10 on which workpieces W (W1) are arranged is carried into a furnace for a steam treatment, and the steam treatment is performed in the furnace. The workpieces W (W1) to which the steam treatment has been completed are transported to the next step, for example, an inspection step, in a state of being arranged on the jig 10. At that time, the jig 10 according to this embodiment can support the workpieces W (W1) in a state of being stacked on the bottom plate of the jig 10 via the lifter plate 12. Therefore, a dead space formed in the case of using a conventional container can be eliminated, which in turn can increase the processing amount of workpieces W (W1). Specifically, it is possible to increase the processing amount of by 30% to 40% compared with the case using a conventional container.

Further, in the jig 10 according to this embodiment, since the stacked workpieces W (W1) are guided or positioned by the guide rod 13 erected on the bottom plate 11, the workpieces W (W1) will not be scratched or damaged during the conveyance due to the collision therebetween. Furthermore, since the opening 18 for allowing the supplied steam to pass through downward is formed in the vicinity of the bottom plate 11 where the workpiece is to be supported, circulation of the steam in the furnace can be improved. In other words, it is possible to suppress or prevent stagnation of the steam in the furnace, which can prevent the occurrence of a film formation defect in the workpiece W (W1).

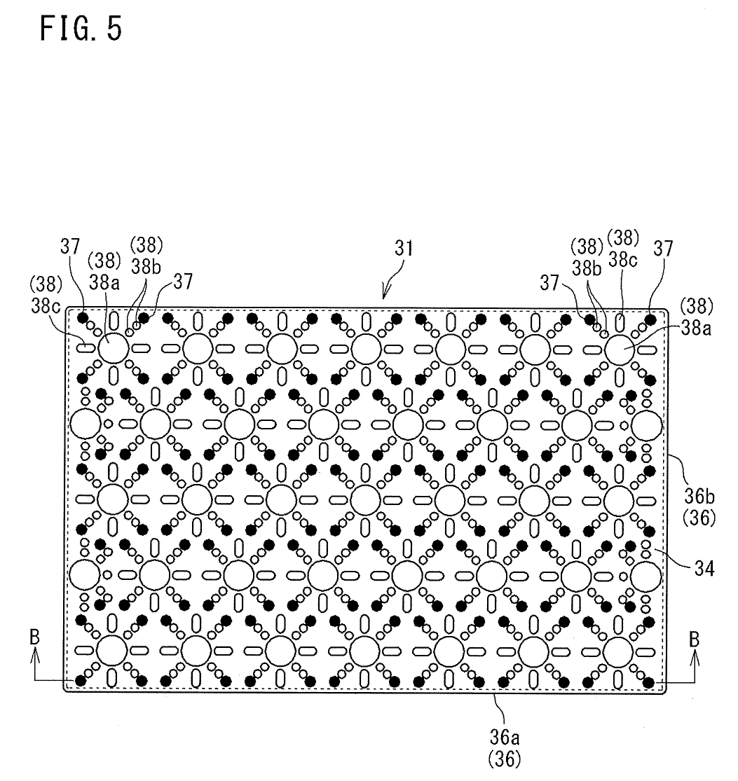

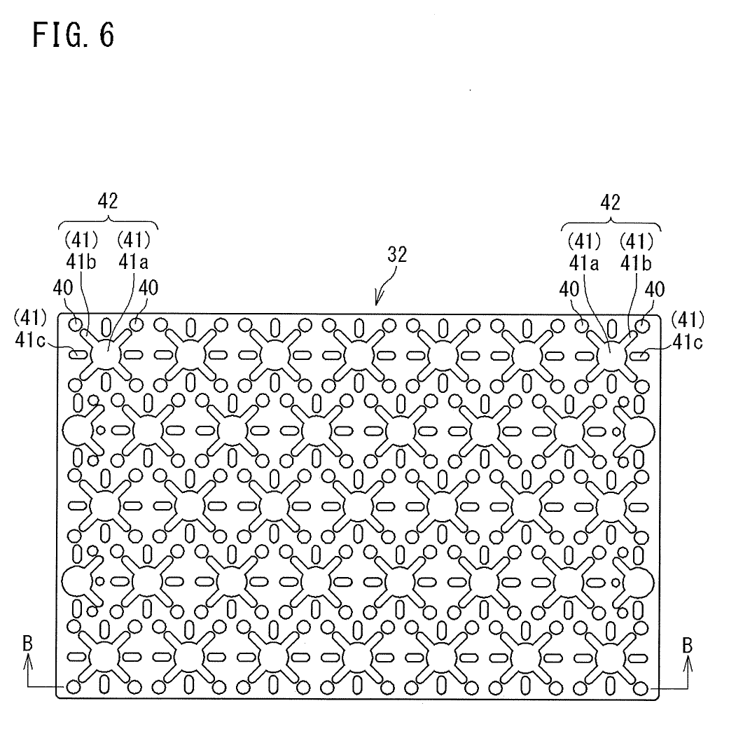

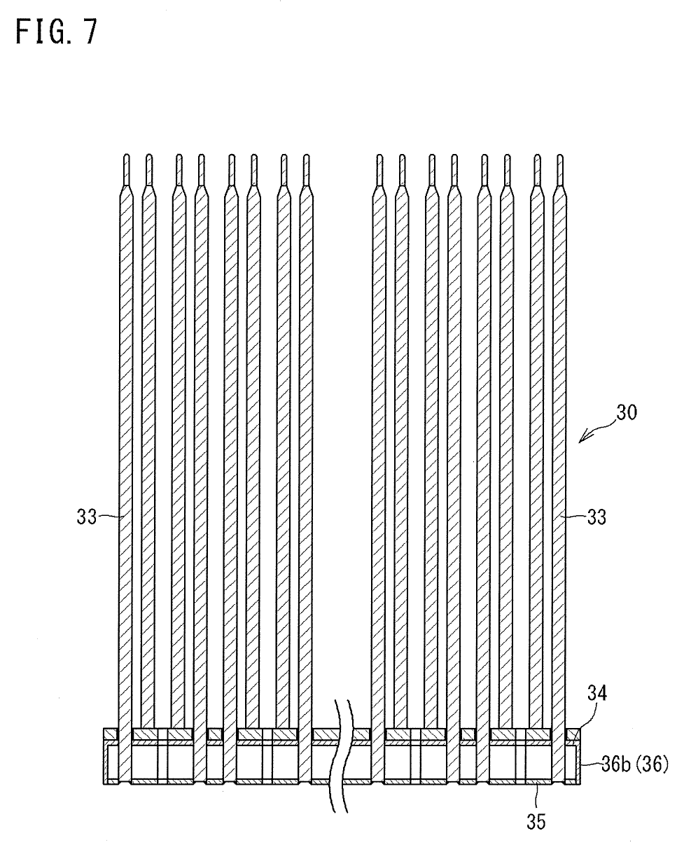

FIGS. 5 to 7 are explanatory views showing one embodiment of a jig for supporting a workpiece having a disk shape similar to the outer rotor W2 shown in FIG. 1 when the workpiece whose inner diameter surface is served as a sliding surface is subject to a steam treatment. In the same manner as in the aforementioned jig 10, the jig 30 according to one embodiment of the present invention is equipped with a bottom plate 31, a lifter plate 32, and guide rods 33 (refer to FIG. 7). FIG. 5 is a plan explanatory view of the bottom plate 31, FIG. 6 is a plan explanatory view of the lifter plate 32, and FIG. 7 is a cross-sectional explanatory view of a jig 30 in which the bottom plate 31, the lifter plate 32, and the guide rods 33 are assembled, and is a cross-sectional view taken along the line B-B when the bottom plate 31 and the lifter plate 32 shown in FIGS. 5 and 6 are combined. The bottom plate 31, the lifter plate 32, and the guide rod 33 can be each made of a general steel material, for example, SS41.

The bottom plate 31 is a member for supporting workpieces W (W2) in a stacked manner, and has a rectangular box shape in the same manner as in the bottom plate 11 shown in FIG. 2. The bottom plate 31 is equipped with a rectangular upper plate 34, a lower plate 35 having the same shape as the upper plate 34, and four side plates 36. The side plate 36 is composed of a side plate 36a on the long side of the rectangular upper plate 34 and the lower plate 35 and a side plate 36b on the short side thereof. The side plate 36 in this embodiment is formed by bending the edge portion of the upper plate 34. The tip end portion of the bent side plate 36 is fixed to the edge portion of the lower plate 35 by welding or the like.

In the upper plate 34 and the lower plate 35 of the bottom plate 31, a round hole 37 which is an opening through which the guide rod 33 is to be inserted and an opening 38 which allows a steam supplied for a steam treatment to pass downward are formed. The round hole 37 and the opening 38 of the upper plate 34 and the round hole 37 and the opening 38 of the lower plate 35 are formed at positions overlapping each other in the vertical direction (vertical direction in FIG. 7) when the upper plate 34 is placed at a predetermined position on the lower plate 35.

The opening 38 is composed of an opening 38a formed of a large round hole, an opening 38b formed of a round hole having a diameter smaller than that of the large round hole, and an oval opening 38c. In FIG. 5, for the sake of clarity, the round hole 37 which is an opening through which the guide rod 33 is inserted is illustrated by a black filled circle. The opening 38 is regularly formed in the vicinity of a part or a region where the workpiece W is supported on the bottom plate 31 in order to improve the flow of the steam around the workpiece W (W2). In this embodiment, the opening 38 and the workpiece W (W2) are partially overlapped in the vertical direction (vertical direction in FIG. 7), but the shape and the arrangement of the opening 38 can be selected so as not to be overlapped with each other.

In this embodiment, four oval openings 38c are formed at equal intervals around the opening 38a, and two openings 38b are formed side by side in the radial direction between two adjacent openings 38c. The type (three types of opening is adopted in this embodiment), the number, the size, and the arrangement of the opening 38 are not particularly limited in the present invention, and they can be appropriately selected in consideration of the easiness of steam circulation, the shape and size of the workpiece, the strength of the bottom plate, etc.

In this embodiment, in FIG. 5, the radially outside of the workpiece W (W2) is guided or positioned by a guide rod 33 inserted into the round hole 37 formed on the radially outer side of the opening 38b on the radially outer side of the two openings 38b formed side by side in the radial direction. That is, in this embodiment, the piece W (W2) is disposed inside the four guide rods 33 arranged on the circumference. The number of guide rods for guiding or positioning the outer diameter side of the workpiece W (W2) is not limited to four, but may be three, or five or more. The arrangement of the guide rod 33 needs to be selected so that the workpiece W (W2) does not move between adjacent guide rods 33.

In the example shown in FIGS. 5 to 7, one set of four guide rods 33 is arranged in five rows in the short side direction of the rectangular bottom plate 31 and in six or seven rows in the long side direction thereof. That is, five (5) sets of guide rods 33 are arranged in the short side direction, and six (6) sets or seven (7) sets of guide rods 33 are arranged in the long side direction. Thirty three (33) sets of guide rods 33 are arranged on one bottom plate 31, and thirty three (33) workpieces W (W2) can be arranged side by side in one stage. In the case of stacking ⁿth stages of workpieces W (W2) on the bottom plate 31, a total of 33×n workpieces W (W2) can be supported on the bottom plate 31.

The guide rod 33 in this embodiment is composed of a solid rod material having a circular cross-section like the guide rod 13 in the embodiment shown in FIGS. 2 to 4, and its structure and fixing method to the bottom plate are the same as the guide rod 13. Therefore, for the sake of simplicity, the explanation of the guide rod 33 will be omitted.

In this embodiment, a lifter plate 32 as shown in FIG. 6 is disposed on the bottom plate 31. The workpiece W (W2) is supported on this lifter plate 32. The lifter plate 32 can be made of a steel material such as SS41 in the same manner as the bottom plate 31. Unlike the bottom plate 31, the lifter plate 32 is made of one sheet material. The lifter plate 32 has a rectangular shape approximately the same size as the bottom plate 31 in a plan view, and is provided with round holes 40 and openings 41 (41a, 41b, 41c) formed at positions corresponding to the positions where the round hole 37 and the opening 38 (38a, 38b, 38c) of the bottom plate 31 are formed, respectively. In other words, when the lifter plate 32 is laid over the bottom plate 31, the position, the size, and the shape of the round holes 40 and the openings 41a, 41b, and 41c of the lifter plate 32 are set so that the round holes 37 and the openings 38a, 38b, and 38c of the bottom plate 31 and the round holes 40 and the openings 41a, 41b, and 41c of the lifter plate 42 substantially coincide vertically so as to be penetrated. However, in the present embodiment, the opening 38a formed of a large diameter round hole and the opening 38b formed of a small diameter round hole are separately formed in the bottom plate 31. In the lifter plate 32, openings 41a and 41b corresponding to the opening 38a and the opening 38b are integrally formed as one opening 42.

The lifter plate 32 is movable up and down along the axial direction of the guide rod 33 by a drive mechanism in the same manner as shown in FIGS. 2 to 4. The supporting method of the workpiece W (W2) using the lifter plate 32 is the same as the embodiment shown in FIGS. 2 to 4, and therefore its explanation will be omitted for the sake of simplicity.

Also in this embodiment, it is possible to support the workpieces W (W2) on the bottom plate of the jig 30 via the lifter plate 32 in a stacked manner. Therefore, a dead space formed in the case of using a conventional container can be eliminated, which in turn can increase the processing amount of the workpieces W (W2). Specifically, it is possible to increase the processing amount by 30% to 40% compared with the case using a conventional container.

Further, in the jig 30 according to this embodiment, the stacked workpieces W (W2) are guided or positioned by the guide rods 33 erected on the bottom plate 31. Therefore, it is possible to prevent the workpieces W (W2) from being scratched or damaged during the conveyance due to the collision therebetween. Furthermore, since the openings 38 for allowing the supplied steam to pass through downward are formed in the vicinity of the bottom plate 31 where the workpiece W (W2) is supported, circulation of the steam in the furnace can be improved. In other words, it is possible to suppress or prevent stagnation of steam in the furnace, which can prevent the occurrence of a film formation defect in the workpiece W (W2).

[Other Modifications]

The present invention is not limited to the aforementioned embodiments, and can be variously modified within the scope of the claims.

For example, in the embodiment described above, a solid rod material having a circular cross-section is used as a guide rod, but rod members having other cross-sectional shapes can also be used. Also, instead of a solid material, a hollow cylindrical body or a square tube body can be used.

In the aforementioned embodiment, a box-shaped member composed of an upper plate, a lower plate, and side plates is adopted as the bottom plate, but the bottom plate can also be composed of one plate member.

### DESCRIPTION OF REFERENCE SYMBOLS

1: round hole
2: outer peripheral teeth
2a: outer peripheral surface
3: inner peripheral teeth
3a: inner peripheral surface
10: jig
11: bottom plate
12: lifter plate
13: guide rod
13a: tapered portion
13b: small-diameter portion
14: upper plate
15: lower plate
16: side plate
16a: side plate
16b: side plate
17: round hole
18: opening
18a: opening
18b: opening
18c: opening
20: opening
21: opening
21a: opening
21b: opening
21c: opening
22: opening
30: jig
31: bottom plate
32: lifter plate
33: guide rod
34: upper plate
35: lower plate
36: side plate
36a: side plate
36b: side plate
37: round hole
38: opening
38a: opening
38b: opening
38c: opening
40: round hole
41: opening
41a: opening
41b: opening
41c: opening
42: opening
W: workpiece
W1: inner rotor
W2: outer rotor

1. A workpiece supporting jig for supporting a plate-shaped workpiece made of a sintered compact when subjecting the workpiece to a steam treatment, comprising:
a bottom plate configured to support a plurality of workpieces in a stacked manner, and
a guide rod erected on one surface of the bottom plate to position stacked workpieces,
wherein an opening configured to allow supplied steam to pass through downward is formed in a vicinity of a portion of the bottom plate on which the workpiece is to be supported.

2. The workpiece supporting jig as recited in claim 1, wherein
a plurality of openings is formed in the bottom plate, and
a total area of the plurality of openings is 14% to 85% of an area of the bottom plate.

3. The workpiece supporting jig as recited in claim 1, wherein
the workpiece is formed into a disc shape,
an inner diameter surface or an outer diameter surface of the workpiece is served as a sliding surface which comes into slide contact with another member, and
the guide rod is erected on an inner diameter side or an outer diameter side opposite to the sliding surface of the workpiece.

4. The workpiece supporting jig as recited in claim 2, wherein
the workpiece is formed into a disc shape,
an inner diameter surface or an outer diameter surface of the workpiece is served as a sliding surface which comes into slide contact with another member, and
the guide rod is erected on an inner diameter side or an outer diameter side opposite to the sliding surface of the workpiece.
